(19) United States
(12) Patent Application Publication
(10) Pub. No.: US 2015/0103687 A1
(43) Pub. Date: Apr. 16, 2015

(54) METHOD AND DEVICE FOR DYNAMIC OPTIMIZATION OF NETWORK PARAMETERS FOR OPTIMAL PERFORMANCE

(71) Applicant: Texas Instruments Incorporated, Dallas, TX (US)

(72) Inventors: Thomas Brian Olson, Allen, TX (US); Harshal S. Chhaya, Plano, TX (US); Binu Ariyappallil Joseph, Rowlett, TX (US)

(21) Appl. No.: 14/515,283

(22) Filed: Oct. 15, 2014

Related U.S. Application Data
(60) Provisional application No. 61/891,153, filed on Oct. 15, 2013.

(51) Int. Cl. H04W 24/02

(52) U.S. Cl. CPC H04W 24/02
USPC 370/252

(57) ABSTRACT

A system, method and device for dynamic optimization of network parameters for optimal performance in a wireless network. The method includes sending at least one reference file to clients, collecting reference files to the clients, measuring performance metrics and updating the low-level parameters to optimize performance.

### CROSS REFERENCES TO RELATED APPLICATIONS

This application claims priority from U.S. Provisional Patent Application No. 61/891,153 filed on Oct. 15, 2013, which is hereby incorporated by reference in its entirety.

### BACKGROUND OF THE INVENTION

1. Field of the Invention

Embodiments of the present invention generally relate to method and device for dynamic optimization of network parameters for optimal performance.

2. Description of the Related Art

Wireless networks are used in a wide variety of applications and environments from airports to factory floors to lecture halls. Each of these applications and environments has unique characteristics that affect the RF signals differently. The factory configurations of the hardware and firmware used in the chipsets may not be optimized for each environment. This mismatch results in sub-optimal performance.

For example, WiFi chipsets have a parameter that defines the signal level at which the channel is considered to be “busy”. If the signal received by a WIFI device exceeds this level, the chipset will not transmit until the value falls below the threshold. For a scenario with a large number of wireless devices in an area, such as, a lecture hall, the default setting may cause performance problems. If this level is set too low by default, the chipset will detect “false positives” and not transmit even when it is safe to do so. If this level is set too high, the chipset may ignore valid transmissions on the channel and start transmitting. In the former case, the performance will be poor due to excessive delays. In the latter case, the performance will be poor due to data corruption and excessive re-transmissions.

Therefore, there is a need for an improved method and device for dynamic optimization of network parameters for optimal performance.

### SUMMARY OF THE INVENTION

Embodiments of the present invention relate to a system, method and device for dynamic optimization of network parameters for optimal performance in a wireless network. The method includes sending at least one reference file to clients, collecting reference files to the clients, measuring performance metrics and updating the low-level parameters to optimize performance.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a system capable of dynamically optimizing network parameters for optimal performance;

FIG. 2 is an embodiment of a block diagram of a device capable of dynamically optimizing network parameters for optimal performance; and

FIG. 3 is an embodiment of a flow diagram depicting a method for dynamically optimizing network parameters for optimal performance.

### DETAILED DESCRIPTION

Optimizing network parameters, such as, retry algorithm, maximum data rate, noise level, performance and connectivity level thresholds and transmission power levels, for each specific scenario ensures optimal system performance. Thus, adding “system tuning” functionality to calibrate the parameters for optimum performance for the specific application. In one embodiment, before the system is used in the specific application, the user can choose to “self tune” the system. As a result, the system switches to a ‘self test’ mode where the system would perform uplink and downlink transfers of a known set of files. After the completing the transfers, the system statistics would be collected and analyzed to determine how well the system performs compared to the expected results.

The “self tune module” would then re-configure all clients with a new set of parameters. In one embodiment, parameter files and sending instructions to load them are then downloaded. In another embodiment, the method to update the parameters would depend on the chipsets used in the product. This process may be repeated until the results matched the expectations or until the system reaches optimum parameters for optimal performance for the specific application. In one embodiment, the “tuning” may be done as part of normal operations, thus, it may not be part of a separate step.

In such an embodiment, the lower-level parameters are tuned to optimize a network's performance regardless of the presence of other networks. Other solutions to improving performance are limited to changing channels and/or the transmitting power of the wireless devices. These are high-level parameters and adjusting these help with reducing interaction with other networks in the same physical area.

As a result, self-tuning network for optimum performance is possible. Also, in such embodiment, parameters may be updated regularly when conditions change, e.g., change in number of clients, physical layout of network etc. In addition, such embodiments are applicable in all application scenarios, in-class use, hotspots at cafes, airports, enterprise usage etc. Furthermore, such solution may be used in either as a separate step or as part of normal operation, may be used with existing “auto channel selection” or “auto power adjustment” mechanisms, and allow the network to be self-adjust for the best performance. Such techniques may not need to be standardized. Rather, they are application level protocol that can work for any network, regardless of actual networking technology, i.e. this will work for WiFi, Bluetooth and other similar technologies.

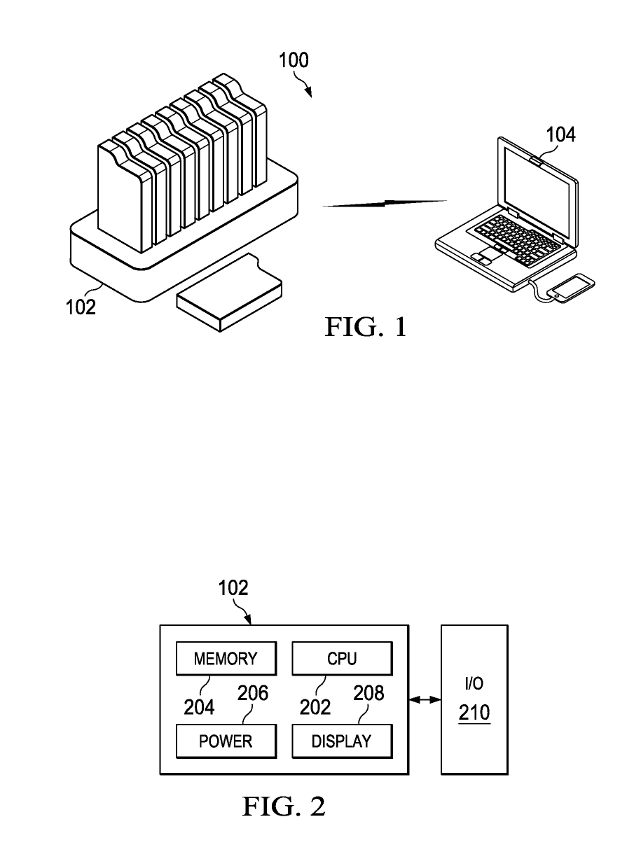

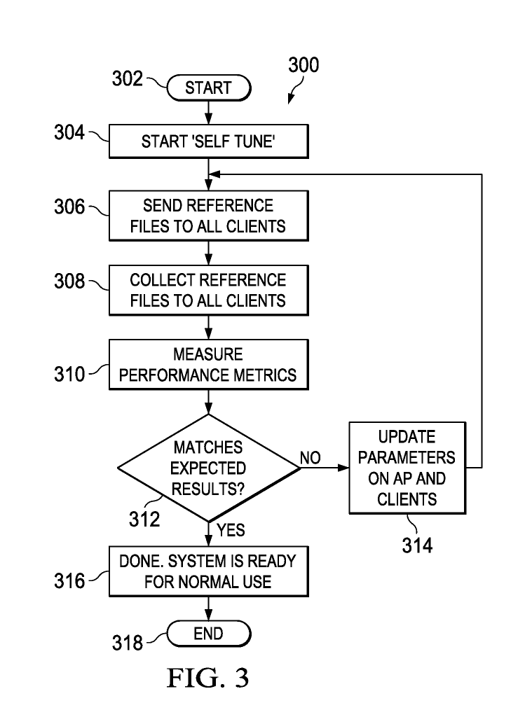

FIG. 1 is an embodiment of a system 100 capable of dynamically optimizing network parameters for optimal performance. The system 100 includes handheld devices 102 and a computer 104. In this embodiment, the handheld devices are shown to be calculators. FIG. 1 depicts 10 handhelds devices 102; however, the mechanism can easily scale to any number of wireless clients. The computer 104 may function as a laptop, desktop, server, host, mainframe, or any device or system capable of connecting to a network. The handheld devices 102 and computer 104 are capable of connecting to a wireless network and performing a method 300, described herein below and shown in FIG. 3.

FIG. 2 is an embodiment of a block diagram of a device 200 capable of dynamically optimizing network parameters for optimal performance. The device 200 includes a CPU 202, a memory 204, power module 206, display 208 and I/O module 210. The device 200 is capable of connecting to a wireless network and of performing a method 300, described herein below and shown in FIG. 3. The CPU 202 may include any suitable combination of software, firmware, and hardware. The CPU 202 may include one or more digital signal processors (DSPs), microprocessors, discrete logic, application specific integrated circuits (ASICs), field-programmable gate arrays (FPGAs), etc. The memory 204 may be internal or external to the device 200 and may be a read only, write only, flash, read/write, transitory, non-transitory and the likes. The power 206 may be electric, battery or solar power. The Input/output (I/O) module 210 may be internal, external or coupled to the device 200. The device 200 is capable of performing the method 300, described herein below.

FIG. 3 is an embodiment of a flow diagram depicting a method for dynamically optimizing network parameters for optimal performance. The method 300 starts at step 302 and proceeds to step 304, wherein the method 300 starts self tuning. At step 306, the method 300 sends reference files to all clients. At step 308, the method 300 collects reference files to all clients. At step 310, the method 300 measures performance metrics. At step 312, the method 300 determines if the outcome matches the expected results. If the outcome does not match, the method 300 proceeds to step 314, wherein the method 300 updates the parameters and the clients and the method 300 returns to step 306; otherwise, the method 300 proceeds to step 316, wherein the method 300 ensures that the system is ready for normal use. The method 300 ends at step 318. The method 300 may be repeated either on-demand or automatically when performance drops below the specified threshold.

While the foregoing is directed to embodiments of the present invention, other and further embodiments of the invention may be devised without departing from the basic scope thereof, and the scope thereof is determined by the claims that follow.

What is claimed is:

1. A device capable of dynamically optimizing network parameters for optimal performance, comprising:
memory for archiving at least one of data or an image; and
processor coupled to the memory configured to perform a method, the method comprising:
sending at least one reference file to clients;
collecting reference files to the clients;
measuring performance metrics; and
updating network parameters to optimize performance

2. The device of claim 1 further comprises repeating the method to further optimize performance.

3. The device of claim 1, wherein the network is a wireless network.

4. The device of claim 1, wherein a client is at least one of a calculator, cellular phone, a handheld device and a computer.

5. The device of claim 1, wherein the method further comprises receiving a request to optimize performance.

6. The method of claim 5 further comprising updating the network parameters when a parameter does not meet a threshold.

7. A method for reliable configuration of network access, comprising:
sending at least one reference file to clients;
collecting reference files to the clients; and
measuring performance metrics; and
updating network parameters to optimize performance.

8. The method of claim 7 further comprises repeating the method to further optimize performance.

9. The method of claim 7 wherein the network is a wireless network.

10. The method of claim 7, wherein a client is at least one of a calculator, cellular phone, a handheld device and a computer.

11. The method of claim 7 further comprising receiving a request to optimize performance.

12. The method of claim 7 further comprising updating the network parameters when a parameter does not meet a threshold.
